(19) United States
(12) Patent Application Publication
(10) Pub. No.: US 2026/0093822 A1
(43) Pub. Date: Apr. 2, 2026

(54) ANALYSIS DEVICE, ANALYSIS METHOD, AND ANALYSIS PROGRAM

(71) Applicant: NTT, Inc., Tokyo (JP)

(72) Inventors: Takuya WATANABE, Musashino-shi, Tokyo (JP); Mitsuaki AKIYAMA, Musashino-shi, Tokyo (JP); Eitaro SHIOJI, Musashino-shi, Tokyo (JP)

(73) Assignee: NTT, Inc., Tokyo (JP)

(21) Appl. No.: 19/110,113

(22) PCT Filed: Sep. 29, 2022
(86) PCT No.: PCT/JP2022/036584

§ 371 Date: Mar. 10, 2025

(51) Int. Cl. G06F 21/57

(52) U.S. Cl. CPC G06F 21/577

(57) ABSTRACT

An analysis device includes processing circuitry configured to describe a scenario of a test to be executed by a browser, cause browsers of a plurality of terminal devices to execute the scenario, and analyze execution results of the scenario executed by the browsers of the plurality of terminal devices.

### TECHNICAL FIELD

The present invention relates to an analysis device, an analysis method, and an analysis program.

### BACKGROUND ART

As a threat to safety of Internet users, there is vulnerability of a web browser (hereinafter, simply referred to as a browser).

In related art, a method for investigating a security problem of a browser is known (see, for example, Non Patent Literature 1 and Non Patent Literature 2).

### CITATION LIST

### Non Patent Literature

Non Patent Literature 1: Gertjan Franken et al. (2018 USENIX), Who Left Open the Cookie Jar? A Comprehensive Evaluation of Third-Party Cookie Policies
Non Patent Literature 2: Meng Luo et al. (2017 CCS), Hindsight: Understanding the Evolution of UI Vulnerabilities in Mobile Browsers

### SUMMARY OF INVENTION

### Technical Problem

However, the techniques in related art have a problem that it may be difficult to comprehensively investigate a security problem of a browser.

For example, the techniques described in Non Patent Literature 1 and Non Patent Literature 2 are for investigating a single function (Cookie or user interface) of a browser, and do not comprehensively investigate a large number of functions.

### Solution to Problem

In order to solve the above-described problems and achieve the object, an analysis device includes: a scenario description unit that describes a scenario of a test to be executed by a browser; an execution control unit that causes browsers of a plurality of terminal devices to execute the scenario; and an analysis unit that analyzes execution results of the scenario executed by the browsers of the plurality of terminal devices.

### Advantageous Effects of Invention

According to the present invention, it is possible to comprehensively investigate a security problem of a browser.

### BRIEF DESCRIPTION OF DRAWINGS

FIG. 1 is a view illustrating a configuration example of an analysis system.

FIG. 2 is a view illustrating a configuration example of an analysis device.

FIG. 3 is a view indicating an example of test result information.

FIG. 4 is a view indicating an example of a Scenario.

FIG. 5 is a view indicating an example of analysis results.

FIG. 6 is a view indicating an example of the analysis results.

FIG. 7 is a view indicating an example of the analysis results.

FIG. 8 is a flowchart indicating flow of processing of the analysis device.

FIG. 9 is a view illustrating an example of a computer that executes an analysis program.

### DESCRIPTION OF EMBODIMENTS

Hereinafter, embodiments of an analysis device, an analysis method, and an analysis program according to the present application will be described in detail with reference to the drawings. Note that the present invention is not limited to the embodiments described below.

### Configuration of First Embodiment

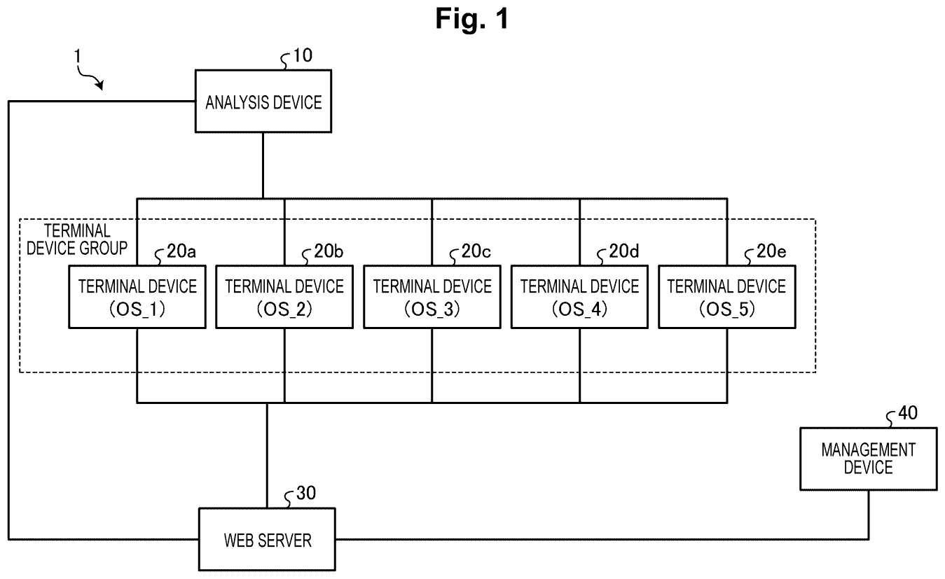

First, a configuration example of an analysis system will be described with reference to FIG. 1. FIG. 1 is a view illustrating a configuration example of the analysis system according to a first embodiment.

As illustrated in FIG. 1, the analysis system 1 includes an analysis device 10, an analysis device group, a web server 30, and a management device 40.

The analysis device 10 creates a scenario of a test for investigating vulnerability of a browser. In addition, the analysis device 10 executes the test according to the created scenario. Specifically, the analysis device 10 causes terminal devices to drive a code generated from the scenario. In addition, the analysis device 10 collects test results from the terminal devices included in a terminal device group and performs analysis.

The terminal device group includes a terminal device 20a, a terminal device 20b, a terminal device 20c, a terminal device 20d, and a terminal device 20e. The terminal devices included in the terminal device group may be physical machine or virtual machine.

The terminal device 20a, the terminal device 20b, the terminal device 20c, the terminal device 20d, and the terminal device 20e have different environments. The environment is, for example, a type of an operating system (OS), a type of a browser, a version of the browser, and the like.

For example, the OSs installed in the terminal device 20a, the terminal device 20b, the terminal device 20c, the terminal device 20d, and the terminal device 20e are OS_1, OS_2, OS_3, OS_4, and OS_5, respectively.

Note that the OS installed in each terminal device may be different from or the same as OSs installed in the analysis device 10, the web server 30, and the management device 40.

For example, the OS is Windows (registered trademark), macOS (registered trademark), Ubunts, Android (registered trademark), iOS, or the like. Further, for example, the browser is Chrome (registered trademark), Firefox (registered trademark), Opera, Safari (registered trademark), or the like.

In addition, the analysis device 10 causes a test to be executed using a method according to the OS of each terminal device. For example, the analysis device 10 operates the terminal device using a remote desktop function according to each OS to execute the test.

In addition, the environment includes whether the terminal device is portable or stationary. Examples of the portable terminal device include a smartphone and a tablet terminal device. The stationary terminal device is, for example, a PC.

The web server 30 provides a web page. For example, the web server 30 transmits a hypertext markup language (HTML) file to the terminal device in response to a request from the terminal device. Furthermore, communication using hypertext transfer protocol secure (HTTPS) is performed between the web server 30 and the terminal device.

The management device 40 is a device for managing the web server 30. The management device 40 communicates with the web server 30 by secure shell (SSH). In addition, the management device 40 starts and manages the web server 30 and changes the web page.

In addition, the analysis device 10 communicates with the web server 30 by, for example, Socket, and confirms whether or not access from the terminal device is possible.

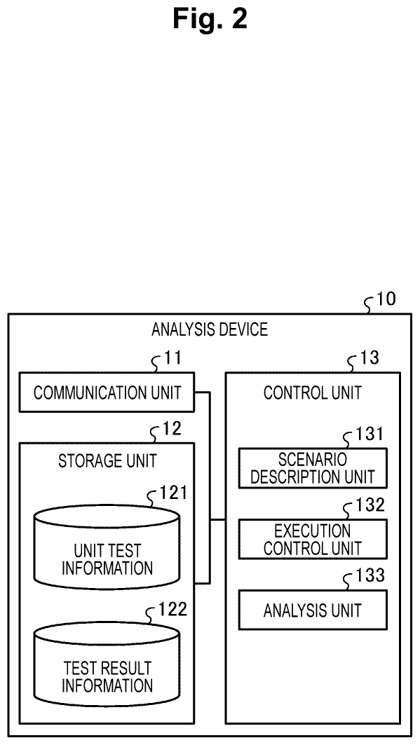

A configuration of the analysis device 10 will be described with reference to FIG. 2. FIG. 2 is a view illustrating a configuration example of the analysis device. As illustrated in FIG. 2, the analysis device 10 includes a communication unit 11, a storage unit 12, and a control unit 13.

The communication unit 11 is an interface for transmitting and receiving data to and from other devices. For example, the communication unit 11 is a network interface card (NIC).

The storage unit 12 is a storage device such as a hard disk drive (HDD), a solid state drive (SSD), or an optical disc. Note that the storage unit 12 may be a semiconductor memory capable of rewriting data, such as a random access memory (RAM), a flash memory, or a non volatile static random access memory (NVSRAM).

The storage unit 12 stores data related to an operating system (OS) and various programs to be executed by the analysis device 10. For example, the storage unit 12 stores unit test information 121 and test result information 122.

The unit test information 121 is information on a unit test which is a unit constituting the scenario of the test. The unit test is, for example, operation of a browser such as “accessing a specified web page”, “selecting permission of authority”, “terminating a browser”, “activating (or restarting) a browser”, “accessing a linked web page”, “inputting a specified character string into a text box”, and “pressing a button”.

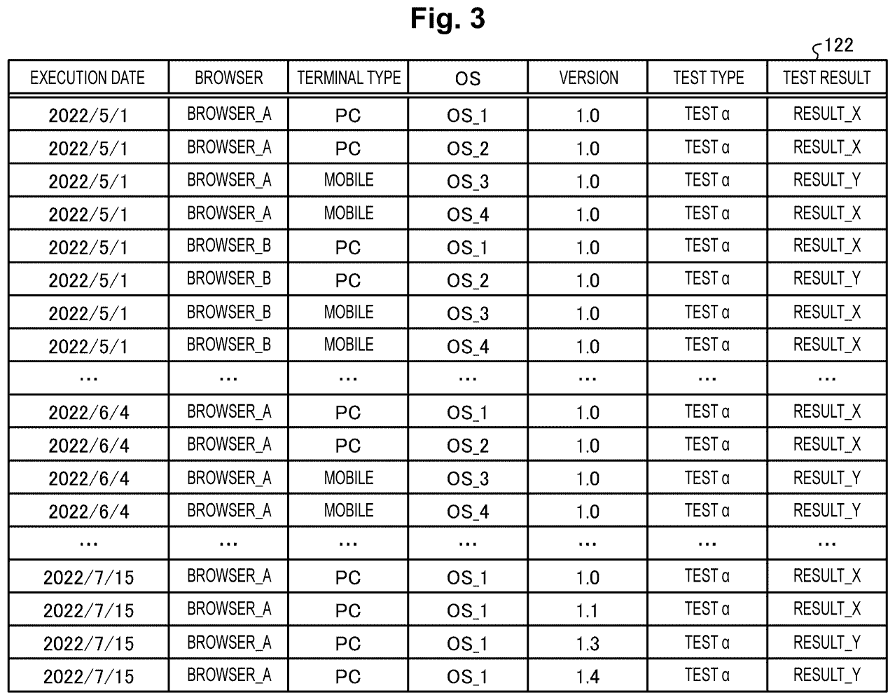

The test result information 122 is results of the test collected from the terminal device group. FIG. 3 is a view indicating an example of the test result information.

As illustrated in FIG. 3, the test result information 122 is data in a table format having items such as “execution date”, “browser”, “terminal type”, “OS”, “version”, “test type”, and “test result”.

The item “execution date” is date on which the test was executed. The test result information 122 may include hour, minute, second, and the like, as execution date and time of the test.

The item “browser” is a type of browser of the terminal device that has executed the test. An arbitrary browser is installed in the terminal device in accordance with the test.

The item “terminal type” is a type of the terminal device that has executed the test. For example, the item “terminal type” indicates whether the terminal device is a portable “mobile” or a stationary “PC”.

The item “OS” indicates a type of the OS of the terminal device that has executed the test. The item “version” is a version of the OS of the terminal device that has executed the test.

The item “test type” indicates a type of the executed test. The type of test corresponds to the scenario. In a case where the scenarios are common, types of tests are common.

The item “test result” represents a result of the test. In the example of FIG. 3, there are two types of test results: “result_X” and “result_Y”. Here, “result_X” means that no vulnerability has been found in the browser in the test. “result_Y” means that vulnerability has been found in the browser in the test.

For example, FIG. 3 indicates that a test result obtained when “test α” was executed using “browser_A” of “PC” with a version “1.0” of “OS_1” in “2022/5/1” was “result_X”.

Further, for example, FIG. 3 indicates that a test result when “test α” was executed using “browser_A” of “mobile” equipment equipped with a version “1.0” of “OS_3” in “2022/5/1” was “result_Y”.

The control unit 13 controls the entire analysis device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

In addition, the control unit 13 includes an internal memory for storing programs and control data defining various kinds of processing procedure and executes each kind of processing using the internal memory. In addition, the control unit 13 functions as various processing units by various programs being executed.

For example, the control unit 13 functions as a scenario description unit 131, an execution control unit 132, and an analysis unit 133.

The scenario description unit 131 describes a scenario of a test to be executed by the browser. The scenario description unit 131 can describe a scenario according to functions to be investigated by combining the unit tests included in the unit test information 121.

The functions to be investigated include browser permission, Cookie implementation, JavaScript (registered trademark) processing, tab implementation, private browsing function, and the like.

The scenario to be described by the scenario description unit 131 is abstracted so as not to depend on the environment. Further, the scenario description unit 131 generates a code corresponding to the scenario.

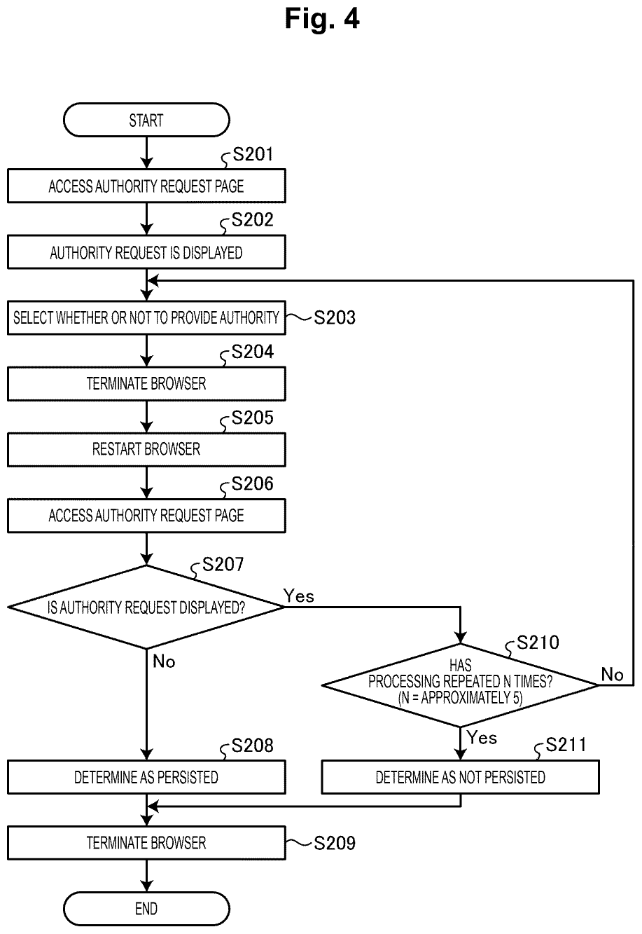

For example, the scenario description unit 131 describes a scenario as indicated in FIG. 4. FIG. 4 is a view indicating an example of the scenario. The scenario may be expressible by a flowchart as indicated in FIG. 4.

In the scenario of FIG. 4, it is investigated whether or not permission of an authority request (browser permission) is persisted. Details of the scenario of FIG. 4 will be described later.

The execution control unit 132 causes browsers of a plurality of terminal devices to execute the scenario. For example, the execution control unit 132 causes the terminal devices to drive a code generated from the scenario by the scenario description unit 131.

As described above, environments of the terminal devices are different from each other. For example, the execution control unit 132 causes the portable terminal device and the stationary terminal device to execute the scenario. In addition, for example, the execution control unit 132 causes a plurality of terminal devices in which at least one of the OS, the type of the browser that executes the scenario, or the version of the browser that executes the scenario is different from each other to execute the scenario.

A case where the terminal device executes the scenario in FIG. 4 will be described. Each step of the flowchart in FIG. 4 corresponds to a unit test.

The terminal device first accesses an authority request page (step S201). The terminal device requests a file of the authority request page from the web server 30. Furthermore, for example, the authority request page requests authority to acquire information (camera image, position information, and the like) from the terminal device via the browser.

Next, the authority request is displayed on the authority request page on the browser of the terminal device (step S202). For example, the authority request is displayed as a pop-up screen including a message and a button for selecting whether or not to provide the authority.

Here, the terminal device selects to provide the authority (step S203). For example, the terminal device performs operation of pressing an “OK” button on the pop-up screen.

Then, after terminating the browser (step S204), the terminal device restarts the browser (step S205). Thereafter, the terminal device further accesses the authority request page (step S206).

Here, after step S206, in a case where the authority request is not displayed on the authority request page again (step S207: No), the terminal device determines that the authority request persists (step S208).

On the other hand, after step S206, in a case where the authority request is displayed on the authority request page again (step S207: Yes), the processing of the terminal device proceeds to step S210.

Here, in a case where the processing from steps S203 to S206 is repeated N times (for example, N=5) (step S210: Yes), the terminal device determines that the authority request does not persist (step S211).

In a case where the processing from step S203 to step S206 is not repeated N times (step S210: No), the processing returns to step S203, and the terminal device repeats the processing.

After step S208 or step S211, the terminal device terminates the browser (step S209).

The analysis unit 133 analyzes execution results of the scenario executed by the browsers of the plurality of terminal devices.

For example, the analysis unit 133 collects, as test results, whether it is determined that the authority request persists or it is determined that the authority request does not persist in each terminal device according to the scenario of FIG. 4. In this manner, the test results are output in binary.

The terminal device may transmit the test results to the analysis device 10 by HTTP communication. In addition, the terminal device may transmit screen captures of the browsers and each UI to the analysis device 10 as the test results. The analysis unit 133 can read the test results from the screen captures by a known image analysis method.

The analysis unit 133 adds the collected test results to the test result information 122. For example, “result_X” indicates that it is determined that the authority request persists. In this case, “result_Y” indicates that it is determined that the authority request does not persist.

Note that as an example, it is assumed here that in a case where permission of the authority does not persist, it is determined that there is vulnerability of the browser, but what kind of test result is determined as vulnerability can be arbitrarily determined by a test performer.

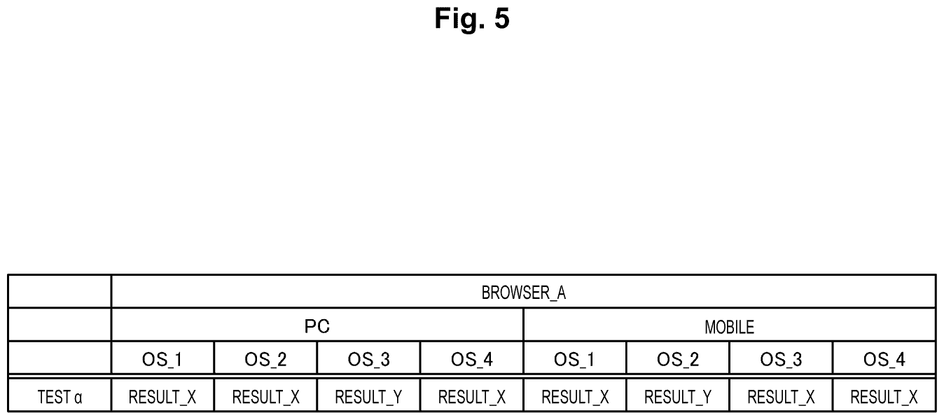

As illustrated in FIGS. 5, 6, and 7, the analysis unit 133 aggregates the execution results for each type of environment in which the scenario is executed. FIGS. 5, 6, and 7 are views indicating examples of analysis results. The analysis unit 133 aggregates the test results for each specific item of the test result information 122. The aggregated results are utilized for triage of vulnerability investigation and detailed investigation.

FIG. 5 illustrates an example of a case where the analysis unit 133 aggregates the test results of the “test α” by the item “OS” and the item “terminal type” and narrows down the test results to those with the browser of “browser_A”.

In a case where a plurality of test results are obtained as a result of the aggregation, the analysis unit 133 sets the largest number of test results among the obtained test results as the aggregated test result. For example, in a case where there are two “result_X” and one “result_X” as a result of the aggregation, the analysis unit 133 sets “result_X” as the aggregated test result.

In addition, the analysis unit 133 may use an average point calculated based on a score set for each test result as the aggregated test result. For example, assume that as a result of the aggregation, a score of “result_X” is 1 point, and a score of “result_Y” is 0 point. As a result of the aggregation, in a case where there are two “result_X” and there is one “result_X”, the analysis unit 133 sets (2×1+1×0)/3=0.66 . . . as the aggregated test result. Furthermore, the average point calculated by the analysis unit 133 may be used for further analysis as a score indicating a degree of vulnerability.

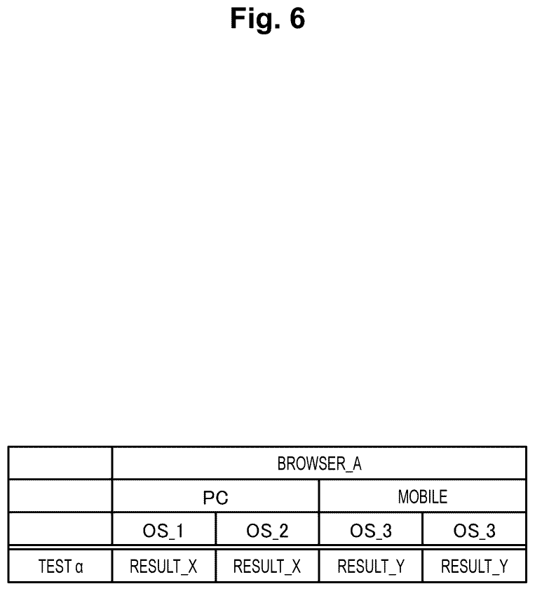

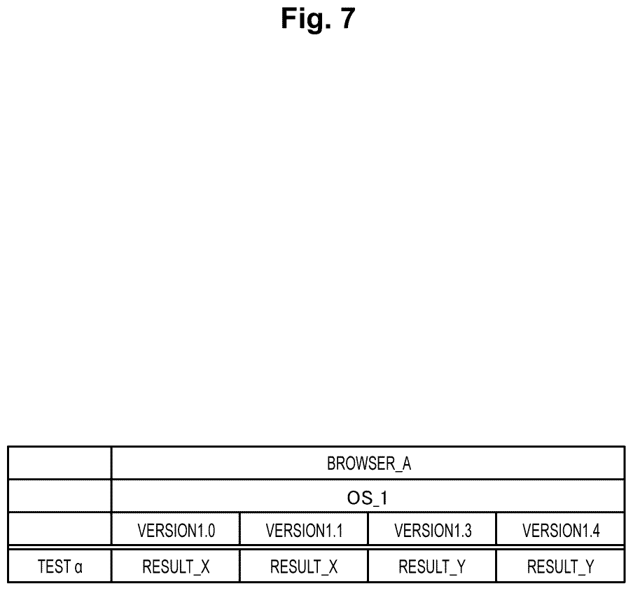

FIG. 6 indicates an example in which the analysis unit 133 further narrows down the results of FIG. 5 to some OSs. FIG. 7 indicates an example in which the analysis unit 133 aggregates the test results of the “test α” by the item “OS”, the item “terminal type”, and the item “version” and narrows down the test results to those with the browser of “browser_A”.

### Flow of Processing of First Embodiment

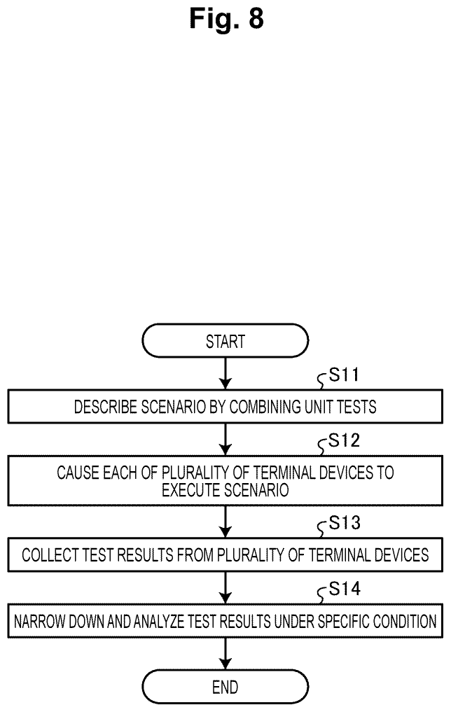

Flow of processing of the analysis device 10 will be described with reference to FIG. 8. FIG. 8 is a flowchart indicating the flow of the processing of the analysis device.

As indicated in FIG. 8, first, the analysis device 10 describes a scenario by combining unit tests (step S11). Next, the analysis device 10 causes each of the plurality of terminal devices to execute the scenario (step S12).

Subsequently, the analysis device 10 collects test results from the plurality of terminal devices (step S13) and narrows down and analyzes the test results under a specific condition (step S14).

### Effects of First Embodiment

As described above, the analysis device 10 includes the scenario description unit 131, the execution control unit 132, and the analysis unit 133. The scenario description unit 131 describes a scenario of a test to be executed by the browser. The execution control unit 132 causes browsers of a plurality of terminal devices to execute the scenario. The analysis unit 133 analyzes execution results of the scenario executed by the browsers of the plurality of terminal devices. According to the first embodiment, by preparing a plurality of terminal devices having different environments, it is possible to comprehensively investigate a security problem of browsers.

In addition, the execution control unit 132 causes the portable terminal device and the stationary terminal device to execute the scenario. As a result, test results can be comprehensively obtained for a plurality of terminal devices having different environments.

In addition, the execution control unit 132 causes a plurality of terminal devices in which at least one of the OS, the type of the browser that executes the scenario, or the version of the browser that executes the scenario is different from each other to execute the scenario. As a result, test results can be comprehensively obtained for a plurality of terminal devices having different environments.

In addition, the analysis unit 133 aggregates the execution results for each type of environment in which the scenario is executed. This makes it possible to analyze in what kind of environment vulnerability is found.

### System Configuration and Others

Further, each of components of the illustrated devices is functionally conceptual, and does not necessarily need to be physically configured as illustrated. In other words, a specific form of distribution and integration of the devices is not limited to the illustrated form, and can be configured by functionally or physically distributing or integrating all or some thereof in any unit depending on various loads, use status, and the like. Further, the whole or any part of processing functions performed in the devices can be implemented by a central processing unit (CPU) and a program analyzed and executed by the CPU, or can be implemented as hardware by wired logic. Note that the program may be executed not only by a CPU but also by another processor such as a GPU.

In addition, among the pieces of processing described in the present embodiment, all or some of the pieces of processing described as being automatically performed can be manually performed, or all or some of the pieces of processing described as being manually performed can be automatically performed by a known method. The processing procedure, control procedure, specific names, and information including various types of data and parameters described above in the specification and drawings can be optionally changed unless otherwise mentioned.

### Program

In an embodiment, the analysis device 10 can be implemented by installing an analysis program that executes the above-described analysis processing as packaged software or online software in a desired computer. For example, an information processing device is caused to execute the above-described analysis program, and thereby the information processing device can be caused to function as the analysis device 10. The information processing device mentioned here includes a desktop or a laptop personal computer. In addition, the information processing device also includes a mobile communication terminal such as a smartphone, a mobile phone, or a personal handyphone system (PHS) , a slate terminal such as a personal digital assistant (PDA), and the like.

In addition, in a case where a terminal device to be used by a user is implemented as a client, the analysis device 10 can be implemented as an analysis server device that provides a service regarding the above-described analysis processing for the client. For example, the analysis server device is implemented as a server device that provides an analysis service having information that specifies a function to be investigated as an input and an analysis result as an output. In this case, the analysis server device may be implemented as a web server or may be implemented as a cloud that provides a service related to the above-described analysis processing by outsourcing.

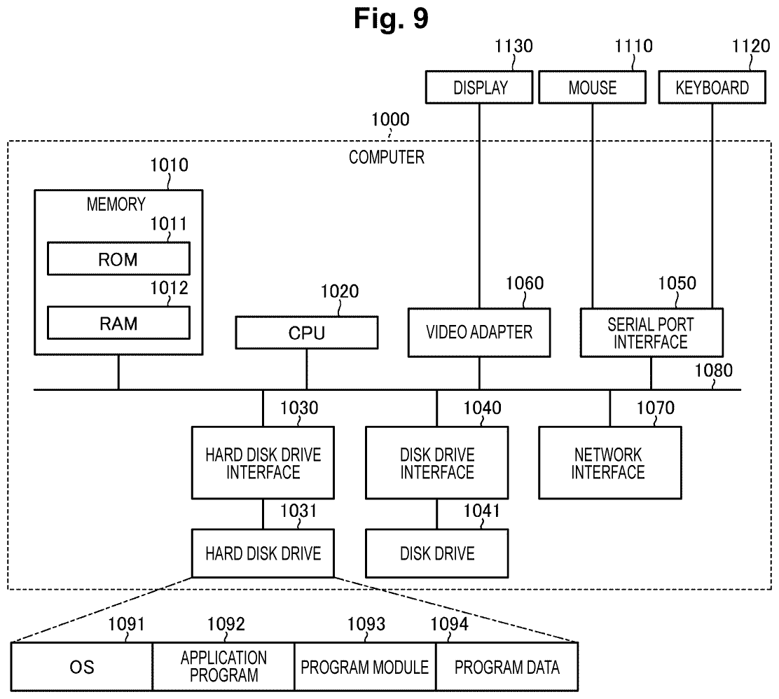

FIG. 9 is a view illustrating an example of a computer that executes the analysis program. A computer 1000 includes a memory 1010 and a CPU 1020, for example. Furthermore, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1110 and a keyboard 1120. The video adapter 1060 is connected to, for example, a display 1130.

The hard disk drive 1031 stores, for example, an OS 1091, an application program 1092, a program module 1093, and program data 1094. In other words, a program that defines each kind of processing operation of the analysis device 10 is implemented as the program module 1093 in which a code executable by a computer is described. The program module 1093 is stored in the hard disk drive 1031, for example. For example, the program module 1093 for executing processing similar to the functional configuration in the analysis device 10 is stored in the hard disk drive 1031. Note that the hard disk drive 1031 may be replaced with an SSD.

In addition, setting data to be used in the processing of the above-described embodiment is stored, for example, in the memory 1010 or the hard disk drive 1031 as the program data 1094. Then, the CPU 1020 reads out the program module 1093 and the program data 1094 stored in the memory 1010 and the hard disk drive 1031 to the RAM 1012 as necessary and executes the processing of the above-described embodiment.

Note that the program module 1093 and the program data 1094 are not necessarily stored in the hard disk drive 1031, but may be stored in a removable storage medium and be read by the CPU 1020 via the disk drive 1041 or the like, for example. Alternatively, the program module 1093 and the program data 1094 may be stored in another computer connected via a network (such as a local area network (LAN) and a wide area network (WAN)). Then, the program module 1093 and the program data 1094 may be read by the CPU 1020 from another computer via the network interface 1070.

### REFERENCE SIGNS LIST

1 Analysis system
10 Analysis device
11 Communication unit
12 Storage unit
13 Control unit
20a, 20b, 20c, 20d, 20e Terminal device
30 Web server
40 Management device
121 Unit test information
122 Test result information
131 Scenario description unit
132 Execution control unit
133 Analysis unit

1. An analysis device comprising:
processing circuitry configured to:
describe a scenario of a test to be executed by a browser;
cause browsers of a plurality of terminal devices to execute the scenario; and
analyze execution results of the scenario executed by the browsers of the plurality of terminal devices.

2. The analysis device according to claim 1, wherein the processing circuitry is further configured to cause a portable terminal device and a stationary terminal device to execute the scenario.

3. The analysis device according to claim 1, wherein the processing circuitry is further configured to cause a plurality of terminal devices in which at least one of an OS, a type of a browser that executes the scenario, or a version of the browser that executes the scenario is different from each other to execute the scenario.

4. The analysis device according to claim 1, wherein the processing circuitry is further configured to aggregate the execution results for each type of environment in which the scenario is executed.

5. An analysis method to be performed by an analysis device, comprising:
describing a scenario of a test to be executed by a browser;
causing browsers of a plurality of terminal devices to execute the scenario; and
analyzing execution results of the scenario executed by the browsers of the plurality of terminal devices.

6. A non-transitory computer-readable recording medium storing therein an analysis program that causes a computer to execute a process comprising:
describing a scenario of a test to be executed by a browser;
causing browsers of a plurality of terminal devices to execute the scenario; and
analyzing execution results of the scenario executed by the browsers of the plurality of terminal devices.
